(19) United States
(12) Patent Application Publication
(10) Pub. No.: US 2026/0053079 A1
(43) Pub. Date: Feb. 26, 2026

(54) DISC MOUNTING ASSEMBLY FOR A VERTICAL TILLAGE IMPLEMENT

(71) Applicant: J A REDEKOP HOLDINGS LTD., Winkler (CA)

(72) Inventors: Waldemar Berg, Winkler (CA); Johan Redekop, Winkler (CA)

(21) Appl. No.: 18/810,016

(22) Filed: Aug. 20, 2024

(51) Int. Cl. A01B 33/08; A01B 33/02

(52) U.S. Cl. CPC A01B 33/087; A01B 33/024

(57) ABSTRACT

In a tillage implement for being towed by an agricultural tractor across ground to be towed and having a main frame supporting a plurality of tillage units thereon in which each tillage unit includes a disc supporting arm mounted on the main frame, disc mounting assemblies support respective tillage discs on the disc supporting arms. Each assembly includes a mounting body forming a socket therein and a shaft partly received within the socket so as to support a tillage disc on a hub rotatable on a portion of the shaft protruding from the mounting body. The shaft includes a tapered shaft section received within a tapered socket section in the socket of the mounting body to securely and releasably mount the shaft relative to the mounting body.

### FIELD OF THE INVENTION

The present invention relates to agricultural implements for vertical tillage including a plurality of disc supporting tillage units supported on a main frame, and more particularly the present invention relates to a disc mounting assembly for rotatably supporting a ground engaging disc on the disc supporting arm of a respective one of the tillage units.

### BACKGROUND

As described in U.S. Pat. No. 9,408,338 by Redekop, in one known form of conservation tillage, the soil is minimally disturbed prior to planting in order to allow air to penetrate the mat of crop residue. This technique is variously known as minimum tillage, residue management, soil aeration or seedbed aeration. A farm implement, sometimes known as a vertical tillage implement, is used to cut the crop residue and penetrate a short distance into the surface of the soil while lifting the soil vertically to permit access of air to the soil.

A known construction of a vertical tillage implement comprises a main frame supporting a plurality of tillage units thereon in which each tillage unit comprises a disc supporting arm which is resiliently mounted relative to the main frame. A disc assembly is then mounted on the trailing end of the disc supporting arm in the form for a shaft and a hub which rotatably supports a ground engaging disc on the shaft. During use of the vertical tillage implement, the soil is fractured in such a manner that a considerable amount of side flowing soil and residue movement results so that the disc mounting arrangements can readily become lodged with debris in a manner than makes maintenance and replacement difficult.

### SUMMARY OF THE INVENTION

According to one aspect of the invention there is provided a disc mounting assembly for mounting a tillage disc on a tillage implement having a main frame supporting a plurality of tillage units thereon in which each tillage unit includes a disc supporting arm mounted on the main frame, the disc mounting assembly comprising:
a shaft extending longitudinally between a first end and an opposing second end in which the second end of the shaft is arranged to support the tillage disc rotatably thereon; and
a mounting body arranged to be supported on a respective one of the disc supporting arms of the tillage implement, the mounting body including a socket formed therein in which the socket receives the first end of the shaft mounted therein;
wherein the shaft includes a tapered shaft section adjacent the first end of the shaft in which the tapered shaft section is tapered to be reduced in diameter towards the first end of the shaft; and
wherein the socket includes a tapered socket section receiving the tapered shaft section matingly therein.

According to a second aspect of the present invention there is provided a tillage implement comprising:
a main frame arranged to be displaced across ground in a forward working direction;
a plurality of tillage units supported on the main frame, each tillage unit including a disc supporting arm mounted on the main frame to extend downwardly and rearward to a trailing end of the disc supporting arm;
a disc mounting assembly supporting a tillage disc on the trailing end of each disc supporting arm, the disc mounting assembly comprising:
   a shaft extending longitudinally between a first end and an opposing second end in which the second end of the shaft supports the tillage disc rotatably thereon; and
   a mounting body supported on the disc supporting arm, the mounting body including a socket formed therein in which the socket receives the first end of the shaft mounted therein;
wherein the shaft includes a tapered shaft section adjacent the first end of the shaft in which the tapered shaft section is tapered to be reduced in diameter towards the first end of the shaft; and
wherein the socket includes a tapered socket section receiving the tapered shaft section matingly therein.

The tapered shaft section received within the tapered socket section allows the shaft of the tillage disc to be firmly secured relative disc supporting arm, while also enabling the shaft to be readily replaced in the event that maintenance is required to the shaft or the disc hub rotatably supported on the shaft.

The disc mounting assembly may further comprises a retaining bolt mounted coaxially with the shaft to retain the first end of the shaft mounted within the socket on the mounting body, in which the retaining bolt extends through an inner end of the mounting body at an inner end of the socket, and in which the retaining bolt is threadably engaged into the first end of the shaft.

When an end plate is supported on the mounting body to span an inner end of the socket so as to receive the retaining bolt therethrough, preferably the end plate is removable from the mounting body with removal of the retaining bolt from the shaft.

The mounting body may comprise a collar arranged to be supported on a trailing end of the disc supporting arm, in which the collar defines said socket therein such that the shaft is mounted coaxially within the collar of the mounting body.

When the disc supporting arm comprises an upright mounting plate at the trailing end of the disc supporting arm and a mounting aperture in the upright mounting plate, the collar of the mounting body may include a first portion having a first diameter arranged to be received within the mounting aperture and a second portion having a dimension transverse to an axial direction of the socket which is greater than a diameter of the mounting aperture.

Preferably the trailing end of the disc supporting arm is arranged to support a second body identical in configuration to the mounting body thereon such that the mounting body and the second body extend from the disc supporting arm in opposing lateral directions. In this manner, the mounting body and the second body receive respective shafts therein such that the shafts are parallel and spaced apart from one another and such that the shafts are arranged to support respective tillage discs thereon at laterally opposing sides of the disc supporting arm.

The tapered shaft section and the tapered socket section may be each tapered at a slope in the range of 2 degrees to 5 degrees from an axis of the shaft. In the illustrated embodiment, the tapered shaft section and the tapered socket section are each tapered at a slope of approximately 3 degrees from an axis of the shaft.

Preferably a minimum outer diameter of the tapered shaft section is at least 1.5 inches and a maximum outer diameter of the tapered shaft section is less than 2.5 inches.

Preferably the tapered shaft section and the tapered socket section each span a length in an axial direction which is greater than a maximum diameter thereof.

One embodiment of the invention will now be described in conjunction with the accompanying drawings in which:

### BRIEF DESCRIPTION OF THE DRAWINGS

FIG. 1 is a perspective view of the disc mounting assembly according to the present invention;

FIG. 2 is another perspective view of the disc mounting assembly according to FIG. 1;

FIG. 3 is a sectional view along a plane locating the disc axes of two discs on a common disc unit;

FIG. 4 is an exploded perspective view of the shaft and the mounting body of one disc mounting assembly according to FIG. 1;

FIG. 5 is a perspective view of an example of a vertical tillage implement having a plurality of disc units thereon, each having a pair of disc mounting assemblies according to FIG. 1 supporting respective ground engaging discs thereon;

FIG. 6 is a sectional view of the mounting body of FIG. 4; and

FIG. 7 is a sectional view of the shaft of FIG. 4.

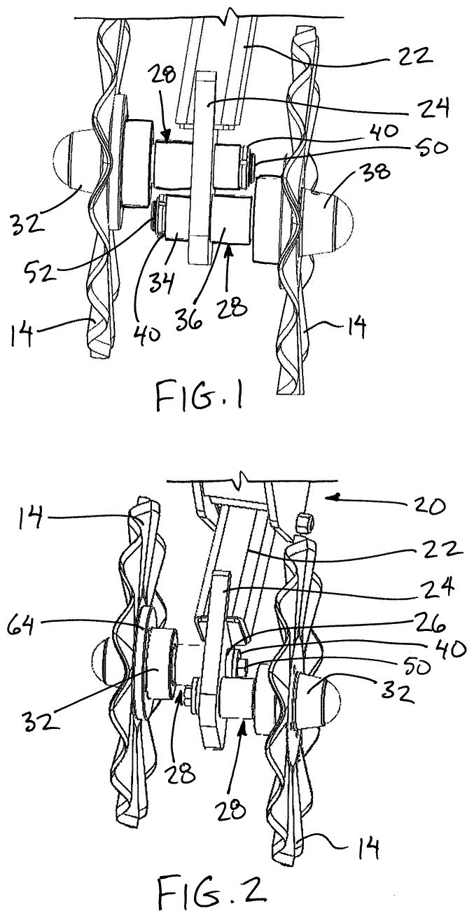

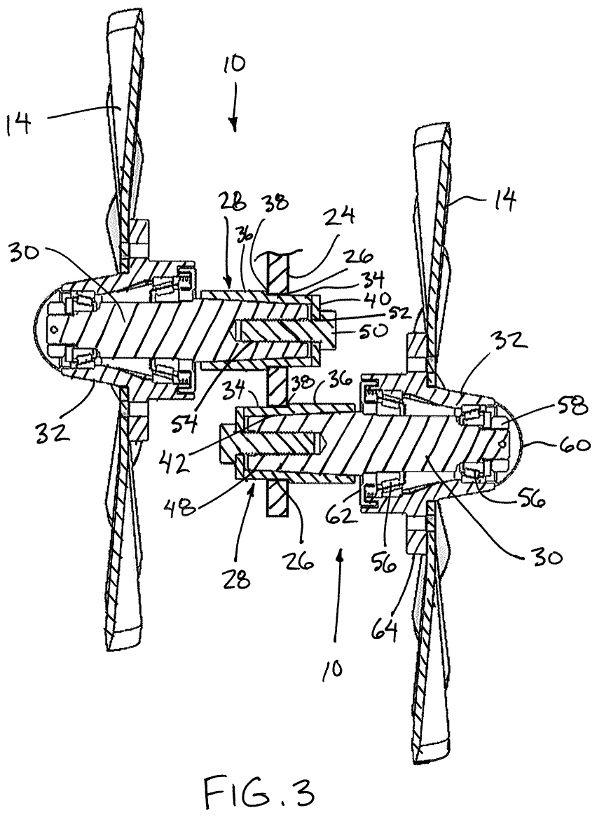

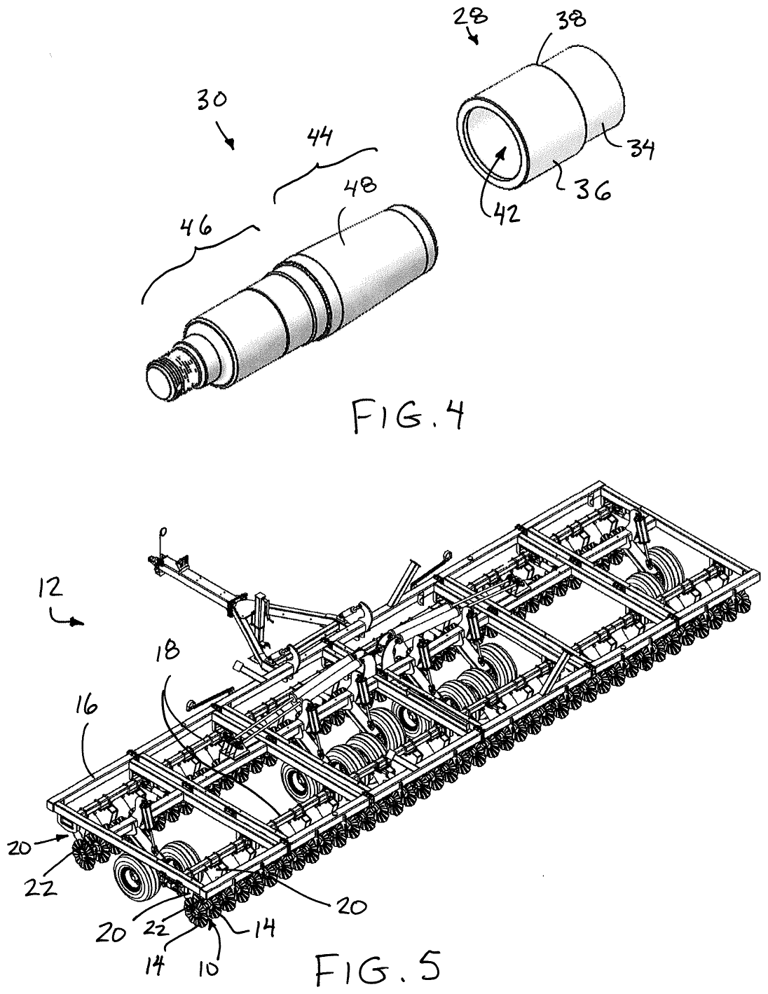

In the drawings like characters of reference indicate corresponding parts in the different figures.

### DETAILED DESCRIPTION

Referring to the accompanying figures, there is illustrated a tillage disc mounting assembly generally indicated by reference numeral 10. The tillage disc mounting assembly 10 is typically used on a vertical tillage implement 12 of the type shown in FIG. 5 for mounting respective tillage discs 14 onto the implement.

According to the illustrated embodiment, the vertical tillage implement 12 includes a main frame 16 arranged for connection to an agricultural tractor to tow the implement for movement across an agricultural field in a forward working direction. One or more tool bars 18 are mounted on the main frame to span horizontally and transversely to the forward working direction. A plurality of tillage units 20 are mounted at spaced positions along each tool bar 18. Each tillage unit 20 includes a disc supporting arm 22 which is supported on the tool bar by a respective resilient connection at the front end thereof such that the support arm trails downwardly and rearwardly from the front end to a rear trailing end supporting respective tillage discs 14 thereon. A spring element (not shown) biases the disc supporting arm 22 downwardly for engagement of the tillage discs 14 at the rear trailing end thereof with the ground while permitting upward deflection of the discs 14 when obstacles are encountered.

In the illustrated embodiment, an upright mounting plate is formed at the trailing end of the disc supporting arm 22 so as to protrude rearwardly from the main beam primarily defining the disc supporting arm 22. Two mounting apertures 26 are formed in the upright mounting plate at spaced apart positions in the longitudinal direction of the disc supporting arm such that the axes of the apertures lie in a substantially common plane that is substantially horizontal or parallel to the ground in use. Each mounting aperture 26 supports a respective disc mounting assembly 10 that supports a respective disc 14 on the disc supporting arm 22 of the respective tillage unit 20. The discs 14 are supported by the disc mounting assemblies 10 such that the discs are laterally offset on opposing sides of the mounting plate 24 and the supporting arm 22.

Each assembly 10 generally includes a mounting body 28 which is fixedly mounted within a respective one of the mounting apertures 26 and a shaft 30 rotatably supporting a disc hub 32 thereon which in turn supports a respective tillage disc 14 thereon such that the disc is rotatable on the shaft 30 with the hub 32.

The mounting body 28 generally comprises a collar defining a socket extending axially through the collar for receiving a first end of the shaft 30 mounted therein. The collar forming the mounting body 28 has an outer diameter which is stepped in profile such that the mounting body comprises (i) a first portion 34 extending from the first end of the collar having an outer diameter which is approximately equal to or slightly less than an inner diameter of a respective mounting aperture 26 that receives the first portion 34 inserted axially therein, and (ii) a second portion 36 spanning from the second end of the collar having an outer diameter which is greater than the inner diameter of the mounting aperture. A shoulder 38 defined at the junction between the first portion 34 and the second portion 36 where the outer diameter increases from the first portion to the second portion. The shoulder 38 comprises an annular surface extending about a circumference of the mounting body and lying perpendicular to an axis of the collar for abutment against a corresponding side of the upright mounting plate 24 in a mounted position of the mounting body 28 on the mounting plate 24. Once the first portion has been inserted into the respective aperture with the shoulder 38 abutted against one side of the mounting plate, a weld bead extends about the circumference of the mounting body, joined between the mounting body and the upright mounting plate 24 to retain the mounting body fixed in place relative to the trailing end of the disc supporting arm.

Each upright mounting plate 24 of a respective tillage unit 20 supports two of the mounting bodies 28 thereon such that open second ends of the mounting bodies protrude laterally outwardly from the upright mounting plate in two opposing directions. The mounting bodies 28 are thus oriented for supporting the respective shafts 30 therein to similarly extend in two laterally opposing directions to support the corresponding pair of tillage discs 14 at laterally opposing sides of the disc supporting arm 22.

An inner first end of each mounting body 28 is selectively enclosed by a respective end plate 40. The end plate 40 is a circular plate having an outer diameter approximately equal to the outer diameter of the first portion 34 of the mounting body at the first end of the mounting body for closing the first end of the socket that extends axially through the collar of the mounting body when the end plate 40 is mounted in place. The opposing second end of the mounting body, corresponding to the end of the second portion 36 of the mounting body, remains open for receiving a portion of the shaft 30 extending therethrough in the mounted position.

The inner diameter of the socket extending through the mounting body 28 is tapered along the full length of the mounting body between the second end and the first end to define a tapered socket section 42 extending axially through the full length of the mounting body 28. More particularly, the inner diameter of the tapered socket section is tapered and reduced gradually along the full length thereof in the axial direction from the second end to the opposing first end of the mounting body that is enclosed by the end plate 40. Conversely, the inner diameter of the tapered socket section 42 gradually increases in the opposing axial direction from the first end to the second end of the mounting body.

The shaft 30 extends axially in a lateral direction of the tillage unit between a first end portion 44 at the first end of the shaft that is mounted into the socket in the mounting body 28 and a second end portion 46 extending from the first end portion 44 towards the opposing second end of the shaft which protrudes from the mounting body in use for rotatably supporting the hub 32 of a tillage disc 14 thereon. The first end portion 44 defines a tapered shaft section 48 having an outer diameter which is sloped so as to be gradually reduced along the length thereof towards the first end of the shaft. The outer diameter along the tapered shaft section 48 closely matches the inner diameter and slope of the tapered socket section 42 within which the tapered shaft section 48 is received in a mounted position.

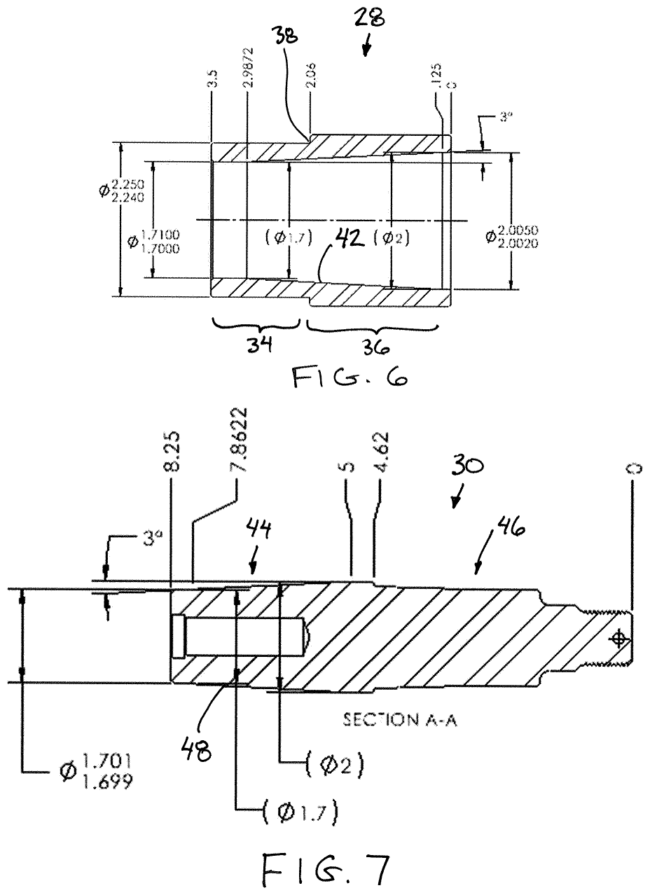

As shown in FIGS. 6 and 7 which are drawn to scale, the diameter of each tapered section has a minimum diameter of approximately 1.7 inches at the first end of the shaft/socket and a larger diameter of 2 inches at the second end of the mounting body corresponding to the opposing end of the tapered section. The overall lengths of the tapered sections are greater than the diameter thereof so as to be approximately between 2.5 and 3 inches in length. In further embodiments, the minimum outer diameter of the tapered shaft section and the minimum inner diameter of the tapered socket section are preferably at least 1.5 inches in diameter, while the maximum outer diameters of the tapered sections are preferably less than 2.5 inches in diameter. The tapered sections thus preferably have a slope deviating from the axial direction in a range between 2 degrees and 5 degrees. In the illustrated embodiment, the tapered sections have a slope of 3 degrees from the longitudinal axis of the shaft and the central axis of the collar forming the mounting body.

The tapered socket section 42 extends farther towards the first end of the mounting body than the tapered shaft section such that the minimum diameter of the tapered socket section is slightly less than the minimum diameter of the tapered shaft section at the first end thereof. In this manner, when the shaft is inserted into the mounting body, the tapered shaft section is wedged into the tapered socket section before the first end of the socket abuts the end plate 40 spanning the first end of the mounting body 28.

The shaft 30 is retained within the mounting body 28 by a retaining bolt 50 mounted coaxially with the shaft to extend through a mounting aperture 52 centrally located within the end plate 40 and into a corresponding mounting bore 54 extending into the first end of the shaft 30. The bore 54 in the first end of the shaft is internally threaded for forming a threaded connection with the retaining bolt 50 such that tightening of the threaded connection causes the head of the retaining bolt 50 to abut the outer side of the end plate 40 which in turn abuts the first end of the mounting body 28, whereby the threaded connection pulls the shaft into the socket in the mounting body to increase wedging of the tapered shaft section into the tapered socket section.

In the mounted position, the second portion 46 of the shaft protrudes out of the open second end of the mounting body 28 as described above. The outer diameter of the second end portion of the shaft is stepped to define axially spaced shoulders that receive two sets of annular bearings 56 abutted thereon. The hub 32 is suitably formed to mount over the bearings 56 to be rotatably supported on the second end portion of the shaft. A retainer nut 58 is threaded onto the outermost end of the shaft which is externally threaded to receive the nut 58 mounted thereon which retains the outermost annular bearing 56 on the shaft. The hub is retained axially between the annular bearings 56. An outer cap 60 is selectively mounted onto the outer end of the hub to enclose the retainer nut 58 within the interior of the hub. An inner cap 62 is mounted on the shaft in fixed relation to the shaft at the junction between first and second end portions 44 and 46 of the shaft to form a rotating seal with the inner end of the hub 32, for example as described in Applicant's corresponding U.S. Pat. No. 9,408,338.

The hub 32 includes a peripheral mounting flange 64 extending radially outward from the hub about the circumference thereof with mounting apertures at circumferentially spaced positions for fastening a respective one of the tillage discs 14 thereon. The tillage disc 14 in the illustrated embodiment is an annular shaped flange extending radially outward from the hub about the full circumference of the hub in which the flange is corrugated about the circumference thereof in the manner of a conventional tillage disc.

The mounting assembly 10, in which the shaft 30 is a tapered shaft section 48 mounted within a corresponding tapered socket in the mounting body 28, allows the shaft to be securely mounted relative to the disc mounting arm, while also allowing the shaft to be quickly replaced when desired. For example, in some instances when dirt enters the interior of the hub 32 by navigating past the rotating seal between the hub and the shaft such that the disc becomes jammed and no longer effectively rotates relative to the shaft or if damage occurs to the hub or shaft, the entire shaft and hub assembly can be replaced so that the tillage implement 12 can be continued to be operated with a replacement hub and shaft, while the hub and shaft undergo maintenance.

Removal and replacement of a shaft 30 from the respective mounting body 28 involves removing the retainer bolt 50 which is externally accessible at the first end of the mounting body. The end plate 40 is readily removed from the mounting body 28 together with the retainer bolt 50 such that the first end of the shaft is exposed through the resulting open first end of the mounting body. Hammering tools can then access the first end of the shaft 30 to provide axial force to eject the shaft 30 from the mounting body by releasing the wedging of the tapered shaft section 48 into the tapered socket section 42.

Since various modifications can be made in my invention as herein above described, it is intended that all matter contained in the accompanying specification shall be interpreted as illustrative only and not in a limiting sense.

1. A disc mounting assembly for mounting a tillage disc on a tillage implement having a main frame supporting a plurality of tillage units thereon in which each tillage unit includes a disc supporting arm mounted on the main frame, the disc mounting assembly comprising:
a shaft extending longitudinally between a first end and an opposing second end in which the second end of the shaft is arranged to support the tillage disc rotatably thereon; and
a mounting body arranged to be supported on a respective one of the disc supporting arms of the tillage implement, the mounting body including a socket formed therein in which the socket receives the first end of the shaft mounted therein;
wherein the shaft includes a tapered shaft section adjacent the first end of the shaft in which the tapered shaft section is tapered to be reduced in diameter towards the first end of the shaft; and
wherein the socket includes a tapered socket section receiving the tapered shaft section matingly therein.

2. The assembly according to claim 1 further comprising a retaining bolt mounted coaxially with the shaft to retain the first end of the shaft mounted within the socket on the mounting body, wherein the retaining bolt extends through an inner end of the mounting body at an inner end of the socket, and wherein the retaining bolt is threadably engaged into the first end of the shaft.

3. The assembly according to claim 1 further comprising an end plate supported on the mounting body to span an inner end of the socket, the end plate receiving the retaining bolt therethrough, and the end plate being removable from the mounting body with removal of the retaining bolt from the shaft.

4. The assembly according to claim 1 wherein the mounting body comprises a collar arranged to be supported on a trailing end of the disc supporting arm, the collar defining the socket therein such that the shaft is mounted coaxially within the collar of the mounting body.

5. The assembly according to claim 4 wherein the disc supporting arm comprises an upright mounting plate at the trailing end of the disc supporting arm and a mounting aperture in the upright mounting plate, and wherein the collar of the mounting body includes a first portion having a first diameter arranged to be received within the mounting aperture and a second portion having a dimension transverse to an axial direction of the socket which is greater than a diameter of the mounting aperture.

6. The assembly according to claim 4 wherein the trailing end of the disc supporting arm is arranged to support a second body identical in configuration to the mounting body thereon such that the mounting body and the second body extend from the disc supporting arm in opposing lateral directions, whereby the mounting body and the second body receive respective shafts therein such that the shafts are parallel and spaced apart from one another and such that the shafts are arranged to support respective tillage discs thereon at laterally opposing sides of the disc supporting arm.

7. The assembly according to claim 1 wherein the tapered shaft section and the tapered socket section are each tapered at a slope in the range of 2 degrees to 5 degrees from an axis of the shaft.

8. The assembly according to claim 1 wherein the tapered shaft section and the tapered socket section are each tapered at a slope of approximately 3 degrees from an axis of the shaft.

9. The assembly according to claim 1 wherein a minimum outer diameter of the tapered shaft section is at least 1.5 inches and wherein a maximum outer diameter of the tapered shaft section is less than 2.5 inches.

10. The assembly according to claim 1 wherein the tapered shaft section and the tapered socket section each span a length in an axial direction which is greater than a maximum diameter thereof.

11. A tillage implement comprising:
a main frame arranged to be displaced across ground in a forward working direction;
a plurality of tillage units supported on the main frame, each tillage unit including a disc supporting arm mounted on the main frame to extend downwardly and rearward to a trailing end of the disc supporting arm;
a disc mounting assembly supporting a tillage disc on the trailing end of each disc supporting arm, the disc mounting assembly comprising:
a shaft extending longitudinally between a first end and an opposing second end in which the second end of the shaft supports the tillage disc rotatably thereon; and
a mounting body supported on the disc supporting arm, the mounting body including a socket formed therein in which the socket receives the first end of the shaft mounted therein;
wherein the shaft includes a tapered shaft section adjacent the first end of the shaft in which the tapered shaft section is tapered to be reduced in diameter towards the first end of the shaft; and
wherein the socket includes a tapered socket section receiving the tapered shaft section matingly therein.

12. The implement according to claim 11 further comprising a retaining bolt mounted coaxially with the shaft to retain the first end of the shaft mounted within the socket on the mounting body, wherein the retaining bolt extends through an inner end of the mounting body at an inner end of the socket, and wherein the retaining bolt is threadably engaged into the first end of the shaft.

13. The implement according to claim 11 further comprising an end plate supported on the mounting body to span an inner end of the socket, the end plate receiving the retaining bolt therethrough, and the end plate being removable from the mounting body with removal of the retaining bolt from the shaft.

14. The implement according to claim 11 wherein the mounting body comprises a collar supported on a trailing end of the disc supporting arm, the collar defining the socket therein such that the shaft is mounted coaxially within the collar of the mounting body.

15. The implement according to claim 14 wherein the disc supporting arm comprises an upright mounting plate at the trailing end of the disc supporting arm and a mounting aperture in the upright mounting plate, and wherein the collar of the mounting body includes a first portion having a first diameter received within the mounting aperture and a second portion having a dimension transverse to an axial direction of the socket which is greater than a diameter of the mounting aperture.

16. The implement according to claim 14 wherein the trailing end of the disc supporting arm supports a second body identical in configuration to the mounting body thereon such that the mounting body and the second body extend from the disc supporting arm in opposing lateral directions, whereby the mounting body and the second body receive respective shafts therein such that the shafts are parallel and spaced apart from one another and such that the shafts support respective tillage discs thereon at laterally opposing sides of the disc supporting arm.

17. The implement according to claim 11 wherein the tapered shaft section and the tapered socket section are each tapered at a slope in the range of 2 degrees to 5 degrees from an axis of the shaft.

18. The implement according to claim 11 wherein the tapered shaft section and the tapered socket section are each tapered at a slope of approximately 3 degrees from an axis of the shaft.

19. The implement according to claim 11 wherein a minimum outer diameter of the tapered shaft section is at least 1.5 inches and wherein a maximum outer diameter of the tapered shaft section is less than 2.5 inches.

20. The implement according to claim 11 wherein the tapered shaft section and the tapered socket section each span a length in an axial direction which is greater than a maximum diameter thereof.
